(19) United States
(12) Patent Application Publication
(10) Pub. No.: US 2013/0191149 A1
(43) Pub. Date: Jul. 25, 2013

(54) LATEX DETECTION AND WARNING SYSTEM AND METHOD

(71) Applicants: Michael Kolberg, Hinckley, OH (US); Lawrence Srnka, Northfield Center, OH (US); Gary Keefe, Brecksville, OH (US)

(72) Inventors: Michael Kolberg, Hinckley, OH (US); Lawrence Srnka, Northfield Center, OH (US); Gary Keefe, Brecksville, OH (US)

(21) Appl. No.: 13/356,997

(22) Filed: Jan. 24, 2012

(51) Int. Cl. G06Q 50/22; G06Q 50/24

(52) U.S. Cl. 705/3; 705/2

(57) ABSTRACT

Provided is an apparatus that stores a formulary. The apparatus includes a memory device that stores the formulary, the formulary comprising a plurality of drug entries. A code reader interprets computer-readable codes. An interface device generates an allergy warning. After a computer-readable code that is associated with a drug entry of the plurality of drug entries is read by the code reader, the apparatus compares drug information of the drug entry to allergen information, and controls the interface device to generate the allergy warning when the drug information and the allergen information match.

### BACKGROUND OF THE INVENTION

1. Field of the Invention

This application relates to a method and system for use in dispensing drugs and, more particularly, to a method and apparatus that involves recognizing that an allergen is present and alerting a user to the presence of the allergen.

2. Description of Related Art

Medical facilities, such as hospitals, often have a pharmacy that inventories drugs commonly used within the facility. The drugs are dispensed under the supervision of a pharmacist for administration to patients during medical procedures. For example, an anesthesiologist may prepare syringes of different drugs to be administered to a patient during a surgical procedure in an operating room. Typically, the anesthesiologist applies a label to each syringe to identify the drug stored therein. The label for each syringe has traditionally included a hand-written note with the drug name so the anesthesiologist can visually distinguish a syringe containing a first drug from another syringe containing a second, different drug.

Using handwritten labels to identify drugs contained in syringes is prone to various different errors. The handwriting may be illegible, the handwritten information may include an error even if it is legible, and there is a limited amount of information that can be written on the label. Any information that is not handwritten on the label must be obtained elsewhere, and may not be readily available prior to administration of the drugs in the syringes to the patient. Further, the sheer quantity of information available for consideration by the anesthesiologist can be overwhelming. Information that may not appear relevant to the anesthesiologist may in fact be important to consider before the drugs are administered to the patient.

For example, patient allergies may be overlooked by personnel at a medical facility at times when the patient is not expected to encounter the specific allergens. The drugs themselves can be allergens that cause allergic reactions in sensitive patients. But other, less-obvious substances, such as the materials found in packaging containing the drugs, for example, can also cause allergic reactions in sensitive patients. And while anesthesiologists may regularly consider the drugs themselves as being potential allergens, the packaging material may be overlooked. For instance, latex is a common allergen to which patients can be exposed while undergoing treatment at a medical facility. Some drug vials have a latex cap that is intended to be pierced by a hypodermic needle when transferring the drug from such a vial to a syringe. A patient with a latex allergy can experience an allergic reaction when subsequently injected with the drug using the hypodermic needle, due to the needle's prior contact with the latex cap of the drug vial.

### BRIEF SUMMARY OF THE INVENTION

Accordingly, it would be desirable to detect the presence of an allergen to which a patient is allergically sensitive and to warn a medical professional of the allergy and/or a potential allergic reaction.

According to one aspect, provided is an apparatus that stores a formulary. The apparatus includes a memory device that stores the formulary, the formulary comprising a plurality of drug entries. A code reader interprets computer-readable codes. An interface device generates an allergy warning. After a computer-readable code that is associated with a drug entry of the plurality of drug entries is read by the code reader, the apparatus compares drug information of the drug entry to allergen information, and controls the interface device to generate the allergy warning when the drug information and the allergen information match.

According to another aspect, provided is an allergy warning method. A plurality of drug entries are received. Each drug entry is associated with a computer-readable code. The plurality of drug entries are stored on a memory device. Allergen information is also received. A code reader reads the computer-readable code associated with a drug entry of the plurality of drug entries. Drug information of the drug entry is compared to the allergen information. An allergy warning is generated when the drug information matches the allergen information.

### BRIEF DESCRIPTION OF THE DRAWINGS

The invention may take physical form in certain parts and arrangement of parts, embodiments of which will be described in detail in this specification and illustrated in the accompanying drawings which form a part hereof and wherein:

FIG. 1 is a schematic diagram of a portion of a computer network in a medical facility;

FIG. 2 is a perspective view of an example computer terminal of the computer network;

FIG. 3 shows a block diagram of the example computer terminal;

FIG. 4 shows an example medical label;

FIG. 5 is a perspective view of a syringe provided with a medical label;

FIG. 6 is a perspective view of a drug vial; and

FIG. 7 is a flow diagram.

### DETAILED DESCRIPTION OF THE INVENTION

Certain terminology is used herein for convenience only and is not to be taken as a limitation on the present invention. Relative language used herein is best understood with reference to the drawings, in which like numerals are used to identify like or similar items. Further, in the drawings, certain features may be shown in somewhat schematic form.

It is also to be noted that the phrase “at least one of”, if used herein, followed by a plurality of members herein means one of the members, or a combination of more than one of the members. For example, the phrase “at least one of a first widget and a second widget” means in the present application: the first widget, the second widget, or the first widget and the second widget. Likewise, “at least one of a first widget, a second widget and a third widget” means in the present application: the first widget, the second widget, the third widget, the first widget and the second widget, the first widget and the third widget, the second widget and the third widget, or the first widget and the second widget and the third widget.

Information about various drugs including, but not limited to, the drugs stored in a pharmacy at a medical facility, can be saved in a computer-accessible database (e.g., a master drug database “MDD”). The MDD is accessible to authorized users in the medical facility, such as the pharmacist. To facilitate inventorying and tracking of drugs within the medical facility, the drugs can be identified by computer-readable codes, as provided by barcodes, radio-frequency identification (RFID) tags, or other types of codes capable of being read in a non-contact manner. The database can store information about a particular drug, such as a drug name, concentration, expiration date, etc., in association with a particular computer-readable code for the drug. Such information can be retrieved from the database when the code is read by a device capable of interpreting such codes (i.e., “a code reader”). Example code readers include barcode scanners, RFID readers and the like.

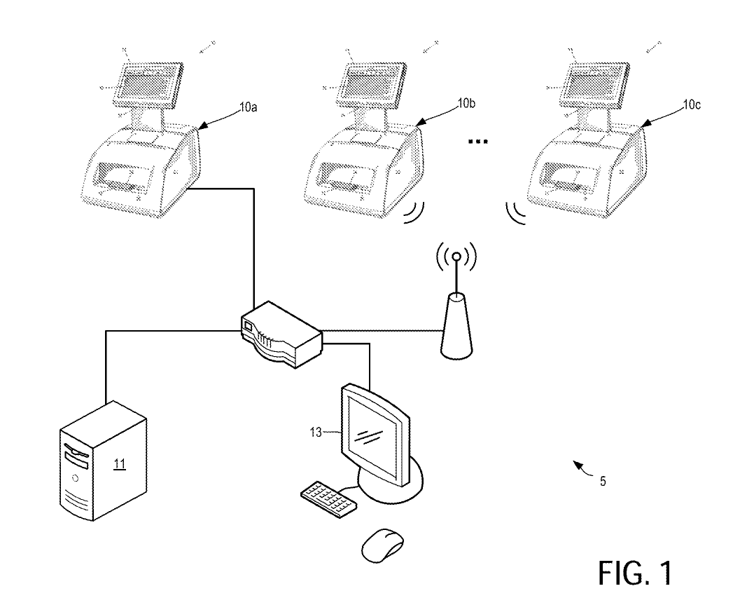

FIG. 1 shows a portion of a network 5 in a medical facility. The network includes a plurality of operating room (“OR”) computer terminals 10a, 10b, 10c (referred to generally at 10), a database server 11, and a pharmacy computer terminal 13. The computer terminal 10 is referred to as an OR computer terminal out of convenience, to explain the drawings in the context of a medical facility (e.g., a hospital). Each OR computer terminal 10 can, but need not be, located in an operating room or otherwise associated with an operating room including a table, and various other surgical instruments commonly employed to perform a surgical procedure on a patient.

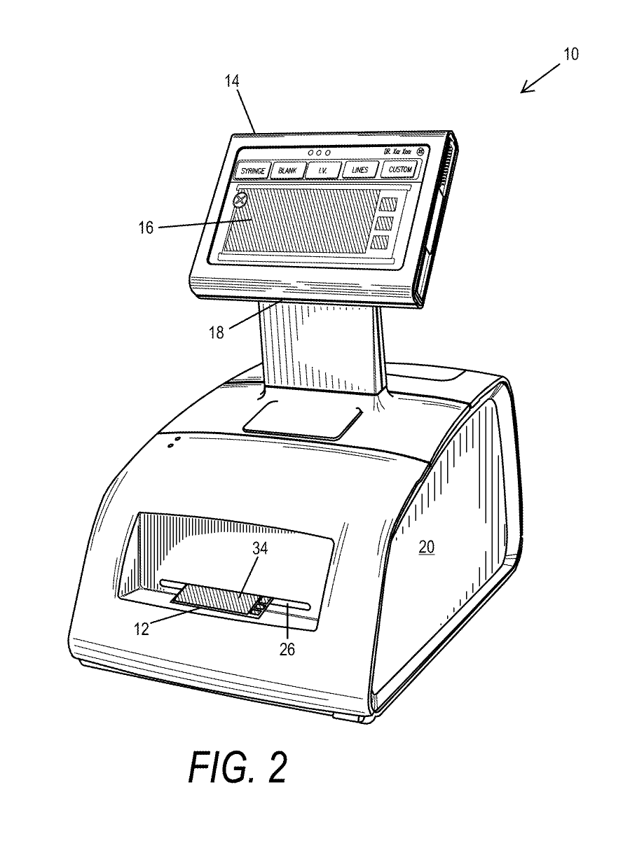

The OR computer terminals 10 generate a label 12 (FIG. 4) including a computer-readable code 50 that encodes, in a computer-readable format, a drug identification code that corresponds to an entry in a formulary 54 (FIG. 2) for that drug stored in a non-transitory computer memory 24 of the OR computer terminal 10. In particular, the label printed can be required to conform to a labeling standard observed in the medical field governing the labeling of that drug.

As shown in FIG. 2, the OR computer terminal 10 includes a touch-screen display 14 that displays a virtual label 16 to be printed as the label 12, and displays soft keys that can be touched by a user to input data and commands into the OR computer terminal 10, such as the verification command discussed above. The virtual label 16 is a computer-generated rendering of the label 12 to be printed that offers the user visual confirmation of the appearance of the physical label 12 to be printed by a printer 26. A code reader 18 can be provided at a convenient location such as adjacent a bottom portion of the display 14 to read a computer-readable code, or can be operatively coupled to the OR computer terminal 10 in any other manner.

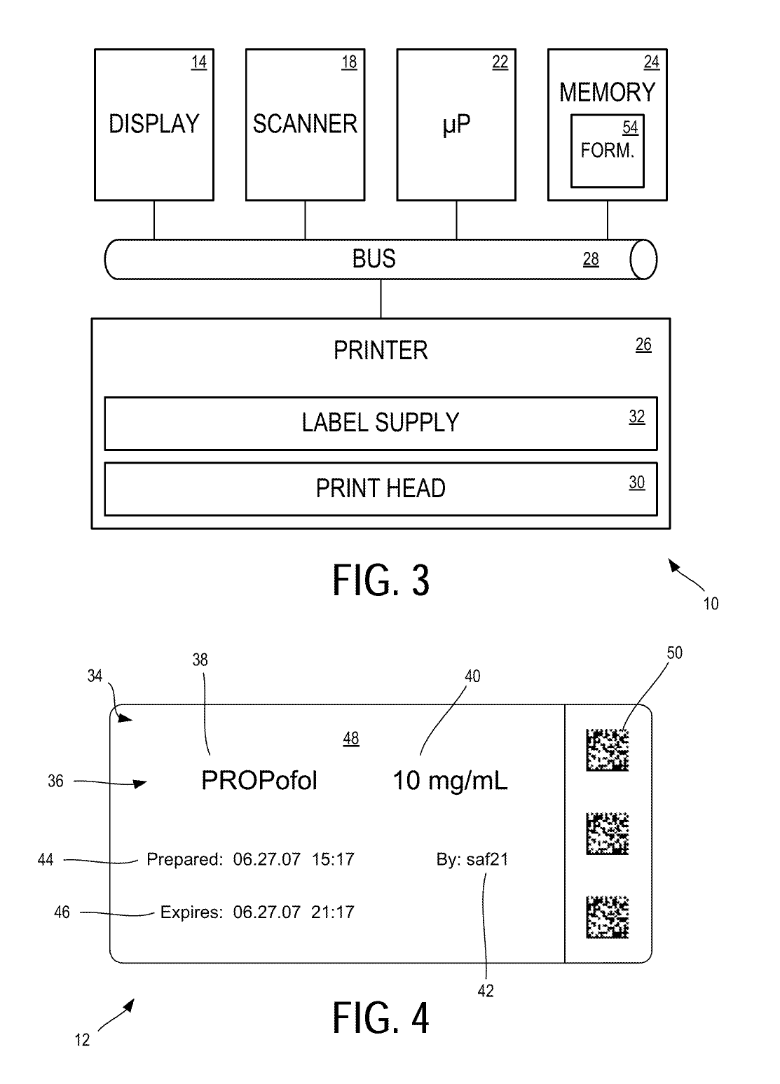

The OR computer terminal 10 includes a cabinet 20 housing components that are operable to produce the label 12 in compliance with a medical labeling standard. The cabinet 20 can also support the display 14 and the code reader 18 to form a self-contained, stand-alone unit. The internal components housed within the cabinet 20 are schematically illustrated by the block diagram of FIG. 3. A computer processor 22 is provided to execute computer-executable instructions stored in a non-transitory computer readable memory 24 such as a hard disk drive, read-only memory (“ROM”), random access memory (“RAM”), optical disc, or any other suitable memory device. The formulary 54 and patient information 56 can be stored in the memory 24. A bus system 28 facilitates communication between components such as the display 14, code reader 18, processor 22, memory 24 and printer 26. Although the OR computer terminal 10 is shown as an integrated, stand-alone unit where the code reader 18, printer 26 and display are all formed as a monolithic unit as part of the cabinet 20, one, a plurality or all of such features can optionally be separate units that are positionable relative to each other, but operatively connected together.

The printer 26 includes a print head 30 for applying label content onto label stock delivered from a supply 32 of labels, which can be blank, or at least in partial compliance with a medical labeling standard. The print head 30 can fall within any category of printing technology suitable to apply label content onto label stock. For example, the print head 30 can be an inkjet print head that deposits droplets of ink in a pattern to create the label content, a laser print head that directs a laser across a photoreceptor to create the pattern for the label content to be printed, a solid-ink print head, a dot matrix print head, and the like.

The label supply 32 can include a roll of label stock that has blank labels supported on a release tape, a tray of individual blank labels, or any other source of labels on which label content is to be printed. The label supply 32 can be internally disposed within the printer 26 or fed into the printer from an external location.

FIG. 4 shows an illustrative embodiment of a label 12 to be generated by the OR computer terminal 10. The label 12, as shown, includes label content that is compliant with, and renders the label 12 compliant with a medical substance labeling standard. For example, the medicinal substance labeling standard can be the guidelines promulgated by the National Safety Patient Goals of the Joint Commission, the American Society of Anesthesiologists, any other medicinal labeling standard established by a professional governing or trade organization or a governmental organization, or any combination thereof. Such guidelines can be based on other medicinal substance labeling standards such as those created by ASTM International, for example. The medicinal substance labeling standards can also require specific sizes, colors and patterns, typefaces and other label content used on labels applied to unlabeled syringes that are filled by the users (i.e., those who will administer the medicinal substance to the patient) or their agents to identify the medicinal substance. Such standards are typically not intended to govern the requirements of labels applied by the drug manufacturer.

The label content required to render the label 12 compliant with a labeling standard created to govern the labeling of any material in the medical field can be specific to the particular standard against which compliance is to be measured. For instance, depending on the medicinal substance labeling standard, the label content can include one, a plurality, or all of the following:

a concentration of a drug to be identified by the label 12,

a dilution of a drug and a diluent used to dilute the drug;

a date and/or time at which the drug was prepared;

an expiration date and/or time of the drug to be labeled;

an identification of an individual who prepared the drug;

a warning about a risk associated with the drug; and

a color to be applied to the label 12 as required by the medicinal substance labeling standard for the particular drug to be labeled.

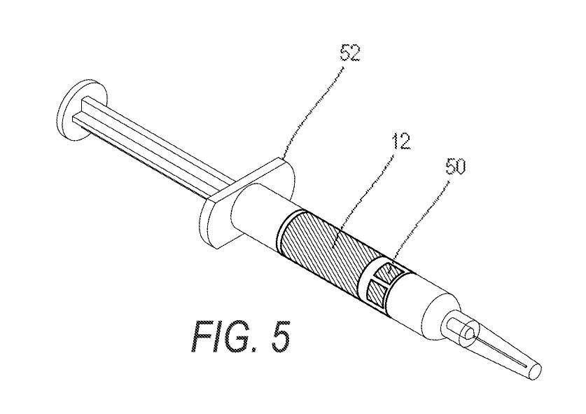

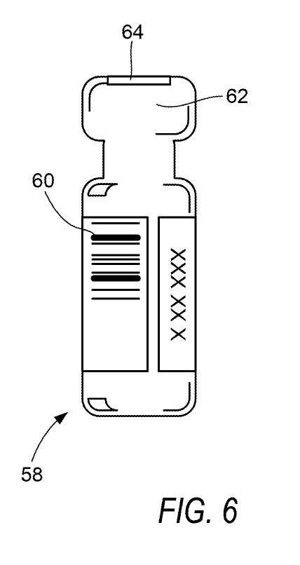

Any portion, or optionally all of the above information can be obtained by the OR computer terminal 10 in response to scanning a computer-readable code 60 (FIG. 6) appearing on a vial label, and encoded by a computer-readable code 50 to be printed as part of the label 12 to be applied to a syringe 52 (FIG. 5). The illustrative embodiment of the label 12 in FIG. 4 is compliant with a medicinal substance labeling standard requiring the name 38 of the drug, which is Propofol in the present embodiment, along with a concentration 40 of the drug, which is 10 mg/mL. The name of the drug can be printed using so-called “tall man lettering” to help emphasize the difference between different medicinal substances with similar spellings. Tall man lettering requires printing a distinguishing portion of the name in all caps, and the remainder of the name in common with the distinguished medicinal substance in lower case letters. The label content 36 on the label 12 also includes the identity 42 of the person who prepared the label 12 and/or the syringe of the medicinal substance, along with the date and time 44 the syringe of the medicinal substance was prepared, and the expiration date and time 46 of that syringe of the medicinal substance.

The label 12 also includes a color code that is visible when viewing the content surface 34 of the label 12. For the illustrative embodiment in FIG. 4, the color code appears as a solid colored background 48 to printed text such as the name 38, concentration 40, identity 42 of the preparer, and preparation and expiration dates and times 44, 46. The color code is specified in this example by the medicinal substance labeling standard. For example, induction agents such as thiopental and ketamine are identified by a solid yellow color code. Tranquilizers such as diazepam and midazolam are identified by a solid orange color background. Narcotics such as morphine and fentanyl are identified by a solid blue color background. Antagonist medicinal substances are denoted by diagonal stripes of the agonist color alternating with white stripes.

The color code can optionally be printed onto the content surface 34 as label content 36 by the printer 26. According to alternate embodiments, the color code is pre-applied to the label 12 to be visible when viewing the content surface 34 by a manufacturer of the label stock before the label 12 is introduced to the printer 26. For such alternate embodiments, the appropriate pre-color-coded label stock is selected from among available label stock that is pre-color coded with a plurality of different colors. Each of the different colors corresponds to a different medicinal substance in accordance with the medicinal substance labeling standard. Thus, several rolls of different colored label stock may be available, and the appropriate roll having the color code corresponding to the medicinal substance to be labeled can be selected.

A computer-readable code 50 can also be printed by the printer 26 as label content 36 on the label 12. The computer-readable code can be a barcode, RFID code, or other suitable code that is indicative of the medicinal substance being labeled. For instance, the computer-readable code 50 can represent the other label content 36, and optionally the color code, for integrating the labeling of the syringe or other container with an Anesthesiology Information Management System (“AIMS”) or other hospital information system.

FIG. 5 shows an illustrative embodiment of a syringe 52 storing a drug that is labeled with the label 12 as printed by the OR computer terminal 10. As shown, the label 12 bearing the computer-readable code 50 can be applied to the syringe 52 and, before administration of the drug, the computer-readable code 50 can be scanned by code reader 18 (FIG. 2) provided to the OR computer terminal 10. The OR computer terminal 10 can optionally display the virtual label 16, and optionally audibly announce the drug identified by the label 12 for confirmation purposes. The user can verify the accuracy of the virtual label 16 by pressing a soft key on the display 14 before the label is printed by the printer 26.

To create the label 12, a computer-readable code 60 on a label provided to a drug vial 58 such as that shown in FIG. 6 is scanned using the scanner 18 of the OR computer terminal 10. The processor 22, receives a signal indicative of an identification code encoded by the computer-readable code 60 and, in response, retrieves a drug entry from a formulary 54 in the memory 24 to identify the drug to be labeled with the label 12, and optionally additional information such as the concentration for example. At least a portion of the information from the formulary 54, optionally in combination with additional information such as allergen information described below entered via the OR computer terminal 10 and/or via a remotely-located computer terminal over the network 5, is encoded in the computer-readable code 50 to appear on the label 12. Thus, when the label 12 is subsequently read by the OR computer terminal 10 or other terminal provided with a machine-readable code reader, the additional information can also be extracted.

The formulary 54 can be created and maintained using information from a master drug database (“MDD”) that is stored on the database server 11. Alternatively, the MDD can be stored on the pharmacy computer terminal 13. For example, the formulary 54 can optionally be created, updated, maintained and distributed to the OR computer terminal(s) 10 as described in U.S. patent application Ser. No. 13/274,184, which is incorporated in its entirety herein by reference. The MDD can contain drug information such as an identity, identification code (e.g., NDC number), concentration, any other pertinent information for each of the drugs used in the hospital, or any combination thereof. The pharmacy computer terminal 13 can execute computer-executable instructions embodied as a software program stored in a non-transitory computer memory provided to the pharmacy computer terminal 13 called an administration tool (“AT”). The AT is to be used by a pharmacist to create and distribute a formulary over a communication network. The formulary includes a subset of the drug entries found in the MDD, and is distributed to the OR computer terminals 10 to serve as a locally-available source of drug information from where the OR computer terminal 10 can look up and retrieve desired information about the drugs within the OR, optionally without communicating with a remotely-located terminal over the communication network as part of the lookup process. The AT can also optionally be used to retrieve drug information from the MDD, update the MDD (e.g., add new drugs to the database or modify existing drug information), etc.

Using information contained in the MDD, the pharmacist selects various drug entries using the AT to be included in the formularies 54 that are to be distributed to, and stored in a memory device 24 (see FIG. 3) of one or more of the OR computer terminals 10. The formulary 54 can include a subset of the MDD selected and added to the formulary 54 using the AT, and the subset can optionally be limited to those drugs that are most-commonly used in the operating room or other location at the medical facility where the OR computer terminal 10 is positioned. The same formulary 54 can optionally be stored in the memory device 24 of more than one OR computer terminal 10, and can optionally be customized to include drugs utilized during surgical procedures relating to a particular medical discipline. For example, the same formulary 54 comprising drugs commonly used during cardiac surgical procedures may be stored in the memory device 24 of multiple OR computer terminals 10, which are each located in a respective OR dedicated for such procedures. Another, different formulary 54 comprising drugs, optionally in appropriate doses, suitable to be administered to children can be stored in the memory of an OR computer terminal 10 located in an OR dedicated for pediatric surgical procedures. According to alternate embodiments, the formulary 54 stored in the memory device 24 of the OR computer terminal 10 can be evaluated and updated, replaced or otherwise changed before each surgical procedure if the OR where the OR computer terminal 10 is located is not dedicated for a particular type of surgical procedure.

When a formulary update is needed to accommodate a specific type of procedure, a pharmacist or other authorized individual can create a new or updated formulary 54 with the AT. The new or updated formulary 54, once complete, can be transmitted over the network 5 (e.g., LAN, WAN or both) in FIG. 1 to each of the OR computer terminals 10, to replace the existing formulary in the memory device 24 with the new or updated formulary. The new or updated formulary 54 can optionally replace the existing formulary 54 in its entirety rather than supplement the information in the existing formulary 54. The new or updated formulary can be transmitted from the pharmacy computer terminal 13 to the OR computer terminal 10 via the network 5 or, according to alternate embodiments, can be transferred to the OR computer terminal 10 from a portable memory device, such as a USB flash memory for example. Once transmitted to the OR computer terminal 10, the formulary is available to be used by the OR computer terminal 10 to relate computer-readable codes scanned as described below to a drug in the formulary. Thus, the OR computer terminal 10 can identify drugs based on such computer-readable codes without operator intervention, and optionally without communicating with a remotely-located computer device via the network 5 once the scanning of the computer-readable code has begun.

The MDD and the formulary 54 store an entry for each drug in the MDD and formulary, respectively. Each entry can be unique, and optionally specific to a specific drug, at a given concentration, with a particular manufacturer or lot number, etc . . . In addition to information identifying the particular drug, each entry can optionally include information about allergens associated with the drug. Such allergen information can optionally be related to substances known to be encountered with the drug, aside from the drug itself, and can optionally include the drug itself according to other embodiments. In other words, the allergen information can include information about substances, other than the drug itself, that are known to be encountered when accessing the drug in preparation of administration of the drug to a patient.

For example, the allergen information can include substances present in packaging used to store the drug. As a specific example, the allergen information can indicate whether a vial or other unit dose container in which the drug is stored includes a cap that contains latex. As shown in FIG. 6, an illustrative embodiment of a drug vial 58 storing a drug is provided with a label including a computer-readable code 60. The drug vial 58 is sealed with a cap 62 comprising a latex membrane 64 that is to be pierced by a hypodermic needle 57 of a syringe such as that shown in FIG. 5 to remove the drug from the vial 58. Accessing the drug in the vial 58 and withdrawing the drug using a syringe necessarily involves exposing the hypodermic needle 57 to the latex membrane 64. When the hypodermic needle 57 is inserted into the patient to administer the drug, the patient is exposed to any residual latex on the hypodermic needle 57 as a result.

Patient allergies to substances, other than the drug itself, such as packaging materials may not be known to those in the OR, or may be overlooked in view of the concern over possible allergies to the drug itself. Accordingly, each entry in the MDD and/or formulary 54 can also include allergen information associated with drug packaging such as latex information about the drug's vial/cap, for example, to allow for a later comparison with patient data including the patient's known allergies, to determine whether the administration of the drug drawn from that packaging to a specific patient is likely to cause an allergic reaction. It is to be appreciated that the drug information can include information on any number of allergens to which a patient might be exposed upon administration of the corresponding drug. For example, in addition to latex information, the drug information can include information on food allergens associated with the drug, such as eggs, for example, that may be a component of the drug, diluent information regarding a diluting agent used to dilute drugs to a desired concentration, or any other such information that may be less-apparent than the drug itself. For the sake of brevity, however, latex information is described as the allergen information, providing an indication in each entry of the MDD and/or formulary 54 whether latex is present in the packaging from which each respective drug is to be withdrawn.

In certain embodiments, the latex information can be manually added to the MDD and/or formulary 54 by a user, such as the pharmacist. For example, using the AT, the pharmacist can manually create a field for each entry in the MDD and/or formulary 54 indicating whether the corresponding drug is stored in a vial with a latex cap. The field can require a yes/no, mutually exclusive selection with a default value of “no” for example, or any other suitable indicator. The pharmacist can determine whether a drug is stored in a vial 58 with a cap 62 containing a latex membrane 64 by visually inspecting the vial. The visual inspection can occur as part of a typical pharmacy inventory process where received drugs are added to the pharmacy's inventory, when dispensing a drug from the pharmacy, when creating the formulary, any combination thereof, etc . . .

According to alternate embodiments, the latex information can be automatically entered into the MDD and/or formulary 54 in response to scanning a computer-readable code 60 during the inventory process. For instance, in response to the pharmacist scanning the computer-readable code 60 encoding the latex information using a barcode reader or other compatible peripheral operatively coupled to the pharmacy computer terminal 13, the pharmacy computer terminal 13 can optionally determine from the computer-readable code 60 that the latex membrane 64 is present, and add this information to the entry corresponding to that drug. Thus, adding that drug entry to the formulary 54 from the MDD also adds the latex information to the formulary 54 for that drug entry.

According to yet other embodiments, an allergen detector such as a latex sensor, for example, can optionally be operatively connected to the OR computer terminal 10. The illustrative latex detector, for example, can make use of a latex-sensitive chemical that reacts to the presence of latex, an illumination source that can illuminate a substance believed to include latex with light having a predetermined, and optionally variable wavelength, an electronic circuit that utilizes an electric signal to detect the presence of latex, and/or any other sensing device. The presence of latex or other allergen as detected by the allergen detector can optionally be automatically received by the OR computer terminal 10 upon being sensed, and/or can be received via manual entry by a user who witnessed a positive test result utilizing the allergen detector. For such embodiments, the presence of latex or other allergen as detected by the allergen detector can be stored in the specific drug entry in the formulary 54 stored by the OR computer terminal 10 for which latex was detected, transmitted over the network 5 to be stored in the MDD for that specific drug entry, transmitted over the network 5 to update the formulary 54 in another OR computer terminal 10, or any combination thereof.

Regardless of how the latex information is entered into the MDD and/or formulary 54, the latex information is transmitted to the OR computer terminals 10 as part of the formulary 54. In use, the OR computer terminals 10 can compare the latex information for a drug identified by the OR computer terminals 10 in response to scanning the computer-readable code 60 on the vial 58 and/or the computer readable code 50 on a label applied to the syringe 52, as described in detail below, to patient information identifying known allergies.

The patient information can be provided to the OR computer terminal(s) 10 in any desired manner, including manually entered at the OR computer terminal(s) 10, automatically entered at the OR computer terminal(s) 10 by reading computer-readable code with a compatible computer-readable code reader, received over the network 5 from an electronic medical record for that patient, which can optionally be stored on the database server 11 that also stores the MDD, or on another server or computer terminal in the medical facility, or in any other desired manner.

For example, a list of known allergens can be provided to the OR computer terminal(s) 10, and optionally stored in the computer-readable memory 24, for example. The list of known allergens can optionally be received by the OR computer terminal(s) 10 over the communication similar to the manner in which the formulary 54 can be received over the network 5. According to alternate embodiments the list of known allergens can be locally delivered on a flash memory or other computer-readable memory. Regardless of how the list of known allergens is received, a user of an OR computer terminal 10 can input an instruction via the touchscreen display 14 to cause the list to be displayed thereon. From the displayed list the user can, based on information available to the user (e.g., patient medical record or chart for example), select one or more of the displayed allergens to be included in the patient information related to the patient that is the subject of a specific medical procedure or session during which the OR computer terminal 10 is to be used. For such an embodiment of receiving the patient information, the OR computer terminal 10 can optionally not identify or possess identifying information that can be used to identify the patient. Instead, the OR computer terminal 10 can simply receive patient information such as an allergen to which the patient may exhibit an allergic reaction.

According to alternate embodiments, an allergen to be included in the patient information can be received by the OR computer terminal 10 by interrogating a computer-readable code encoding the allergen(s) to be included. For example, a patient's wristband, medical chart, ID card, or other item related to a specific patient that is to be the subject of a medical procedure can include a barcode as the computer-readable code encoding the allergen(s) to be received, and optionally stored, by the OR computer terminal 10 as part of the patient information. For such embodiments, the barcode on the wristband or other item specific to the patient can be read by the scanner 18 operatively provided to the OR computer terminal 10. The OR computer terminal 10 can interpret the non-transitory signal resulting from the reading of the barcode by the scanner 18 to receive and optionally store the allergen(s) to which the patient may exhibit an allergic reaction upon being exposed to such allergen(s).

The patient information described herein includes information about one or more known allergens to which the patient is sensitive and/or allergies that the patient may have. Example allergens that can be included in a patient's allergen information include drug allergens (e.g., specific drugs or groups or families of drugs known to cause an allergic reaction in the patient), food allergens (e.g., eggs, legumes, etc.), plant allergens (e.g., grasses, pollens, etc.), animal allergens, materials as allergens (e.g., latex, metals, etc.), and the like. The allergen information can also indicate whether the patient has no known allergies.

One or both of the OR computer terminal 10 and the administration tool AT on the pharmacy computer terminal 13 can compare the allergen information of one or more patients with drug information (e.g., drug identity and/or latex information) and can generate an allergy warning when the allergen information and the drug information match. The allergy warning will alert the pharmacist, doctor, etc. using the AT or the OR computer terminal to the possibility of an allergic reaction by a patient, should the drug be administered to that patient. Example allergy warnings include visual warnings displayed on an interface device, audible warnings broadcast by the interface device, audio/visual warnings, printed warnings, and the like. For example, if the patient is allergic to latex, and drug information from a formulary indicates that a particular drug is stored in a vial with a latex cap, a latex allergy warning can be displayed on a screen of the OR computer terminal 10 or the pharmacy computer terminal 13. The allergy warning can include an identification of the specific patient and/or the allergen/drug information that triggered the warning. The comparison of the allergen information with the drug information can occur before, after or while a formulary is created by the pharmacist.

According to yet other embodiments, the OR computer terminal 10 can receive the identity of one or more patients as data input to the OR computer terminal 10. For example, before beginning a surgical procedure, an anesthesiologist can enter a patient's identity information into the OR computer terminal 10 (e.g., scanning a barcode, keying in a patient's last name or ID number, etc . . . ). Based on the patient's identity information, the OR computer terminal 10 can attempt to retrieve that patient's electronic medical record via the network 5 from the database server 11 or other network-accessible computer storage device. Patient information 56, including known allergies obtained from the electronic medical record, can be stored in the memory 24 of the OR computer terminal 10 (FIG. 3). In response to scanning the computer-readable code 60 on the vial 58 and/or the computer-readable code 50 on the label 12 provided to the syringe 52, the OR computer terminal 10 can then compare allergen information for that drug entry in the formulary 54 to the patient's known allergies to determine whether to generate an allergy warning (e.g., a drug allergy warning or a latex allergy warning).

In certain embodiments, the comparison of allergen information to the patient's known allergies occurs after the computer-readable code 60 and/or 50 that is associated with the drug is read by a coder reader 18 at the OR computer terminal 10. For example, in preparing for surgery, the anesthesiologist can sequentially scan the barcodes used to label several drugs to be used during the surgery. After each scan, the OR computer terminal 10 can compare the drug information, including the allergen information, for the scanned drug to the known allergies of the patient who is to receive the drug. The anesthesiologist will be warned if the allergen information identified by scanning the computer-readable code 60 and/or 50 indicates an allergen that is also included among the patient's known allergies. In certain embodiments, the OR computer terminal 10 can require the user (pharmacist, doctor, etc.) to acknowledge an allergy warning via an appropriate input (pushbutton, soft key entry, etc.) before further actions are allowed to document the fact that the anesthesiologist was alerted to the presence of an allergen that the patient may be allergic to before proceeding.

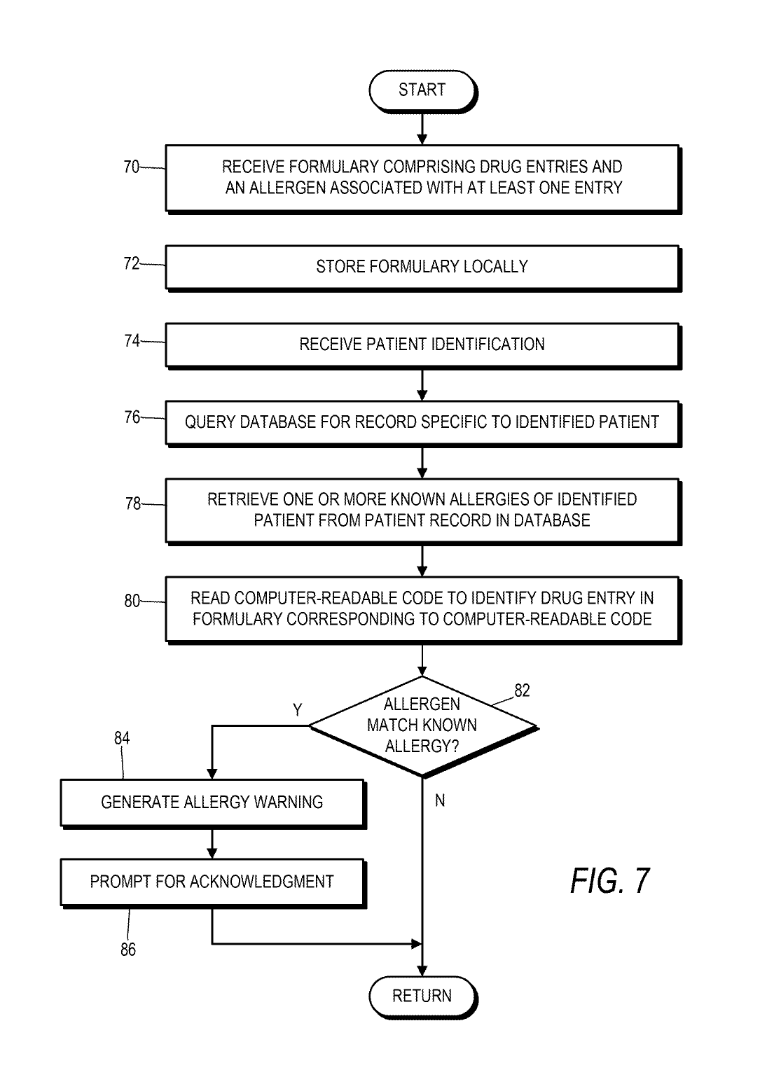

An example method of generating an allergy warning is shown in flow diagram form in FIG. 7. In step 70, a plurality of drug entries associated computer-readable codes are received (e.g., received by the OR computer terminal, database server, and/or the pharmacy computer terminal). For example, the plurality of drug entries can be received in a formulary comprising drug information of the plurality of drug entries that is transferred to the OR computer terminal from the pharmacy computer terminal. The plurality of drug entries are stored on a memory device (step 72), such as memory device 24 in the OR computer terminal (FIG. 3), a memory device of the database server, and/or a memory device of the pharmacy computer terminal. A user inputs patient identity information (step 74), and an electronic medical record database is queried (step 76) to obtain patient information including allergen information (step 78), based on the patient identity information. A code reader reads a computer-readable code associated with a drug included among the plurality of drug entries (step 80). In response to reading the computer-readable code, the OR computer terminal compares drug information of the drug entry to the allergen information (step 82). The OR computer terminal 10 generates an allergy warning when it is determined at (step 82) that the drug information matches the allergen information (step 84). In certain embodiments, the OR computer terminal automatically prompts a user to acknowledge receiving the allergy warning before proceeding with label printing (step 86).

Illustrative embodiments have been described, hereinabove. It will be apparent to those skilled in the art that the above devices and methods may incorporate changes and modifications without departing from the general scope of this invention. It is intended to include all such modifications and alterations within the scope of the present invention. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A drug management apparatus comprising:
a memory device that stores a formulary, the formulary comprising a plurality of drug entries that each comprise an identification of a drug, wherein at least one of the drug entries included in the formulary comprises an allergen associated with the drug identified by the identification;
a code reader that interprets a computer-readable code and transmits a signal to be used to determine the identification of the drug associated with the computer-readable code;
a processing component that identifies the drug in the formulary based on the signal and conducts a comparison of the allergen associated with the drug identified to a known allergy of the patient; and
an interface device that generates an allergy warning in response to a match between the allergen and the known allergy returned by the comparison.

2. The apparatus of claim 1, wherein the known allergy is associated with at least one specific patient.

3. The apparatus of claim 2, wherein the known allergy of the patient is stored in an electronic medical record database and received by the drug management apparatus over a communication network.

4. The apparatus of claim 1, wherein the formulary includes the drug information.

5. The apparatus of claim 1, wherein the allergen includes an indication that latex is present in packaging from where the drug to be administered is retrieved.

6. The apparatus of claim 5, wherein the allergy warning includes a latex allergy warning.

7. The apparatus of claim 1, wherein the interface device comprises a touch-screen interface that prompts a user to acknowledge receipt of the allergy warning.

8. The apparatus of claim 1, wherein the code reader comprises a barcode scanner, and the computer-readable code comprises a barcode, the apparatus further comprising a printer for printing a label including a name of the drug entry and the barcode, wherein the label is compliant with a medical labeling standard, and the interface device further comprising a display that displays the allergy warning and further displays an image of the label.

9. An allergy warning method, comprising the steps of:
receiving a plurality of drug entries, each associated with a computer-readable code;
storing the plurality of drug entries on a memory device;
receiving a known allergy of a patient;
reading, with a code reader, the computer-readable code associated with a drug entry of the plurality of drug entries, wherein the computer-readable code encodes an allergen associated with at least one of the drug entries;
comparing the allergen of the drug entry to the known allergy; and
generating an allergy warning in response to a determination that the allergen matches the known allergy.

10. The method of claim 9, wherein the plurality of drug entries are received in a formulary.

11. The method of claim 10, wherein the formulary includes an entry corresponding to each drug and the allergen associated with the drug.

12. The method of claim 9, wherein the known allergy is associated with at least one specific patient, and is retrieved from an electronic medical record database.

13. The method of claim 12, further comprising receiving an identity of the at least one specific patient.

14. The method of claim 9, wherein the allergy includes an indication that latex is present in packaging where the drug is to be retrieved.

15. The method of claim 14, wherein generating the allergy warning includes generating a latex allergy warning.

16. The method of claim 9, wherein the allergy warning is displayed by a touch-screen interface that also displays a prompt for a user to acknowledge receipt of the allergy warning.

17. The method of claim 9, wherein the code reader comprises a barcode scanner, and the computer-readable code comprises a barcode, the method further comprising printing a label including a name of the drug and the barcode, wherein the label is compliant with a medical labeling standard.

18. The method of claim 17, further comprising transferring a formulary including the plurality of drug entries to a printing apparatus, the printing apparatus including the barcode scanner, a printer that prints the label, and an interface device that displays the allergy warning and further displays an image of the label.
